(19) United States
(12) Patent Application Publication
(10) Pub. No.: US 2002/0083107 A1
(43) Pub. Date: Jun. 27, 2002

(54) Fast fourier transform processor using high speed area-efficient algorithm

(75) Inventors: Hyun-cheol Park, Kyungki-do (KR); Yon-ho Jung, Seoul (KR); Jae-seok Kim, Kyungki-do (KR); Youn-ji Tak, Seoul (KR); Jun-hyun Park, Seoul (KR)

Correspondence Address: SUGHRUE, MION, ZINN,, MACPEAK & SEAS, PLLC, Suite 800, 2100 Pennsylvania Avenue, N.W., Washington, DC, 20037-3213, US

(73) Assignee: SAMSUNG ELECTRONICS CO., LTD.

(21) Appl. No.: 09/970,695

(22) Filed: Oct. 5, 2001

(30) Foreign Application Priority Data
Nov. 3, 2000 (KR) 2000-65248

(51) Int. Cl. G06F 15/00

(52) U.S. Cl. 708/404

(57) ABSTRACT

The present invention discloses a fast Fourier transform (FFT) processor using a high speed area-efficient algorithm. The FFT processor is embodied by using the algorithm including a radix-4 butterfly module for receiving four input signals, and performing a butterfly operation thereon, and a radix-2 butterfly module connected to the radix-4 butterfly module, for performing the butterfly operation on the output signals from the radix-4 butterfly module. As a result, a number of nontrivial complex multipliers is reduced, to perform the FFT in a high speed in a small area.

### BACKGROUND OF THE INVENTION

1. Field of the Invention

The present invention relates to a fast Fourier transform (FFT) processor, and in particular to an improved high speed area-efficient FFT processor.

2. Description of the Related Art

In general, a fast Fourier transform (FFT) transforms a time variation signal into a frequency variation signal, and an inverse fast Fourier transform (IFFT) transforms the frequency variation signal into the time variation signal. hi order to perform the FFT operation on a high speed digital signal in a real time, software embodied by a programmable digital signal processor (DSP), or a private use FFT processor is employed.

Exemplary FFT operations are implemented in wireless LAN, asymmetrical digital subscriber line (ADSL), digital audio broadcasting (DAB), and orthogonal frequency division multiplexing (OFDM) of multi-carrier modulation (MCM).

A communication method using a multi-carrier has been suggested in the multimedia radio data communication so as to provide data in various services and transmission speed. Here, the OFDM has been popularly used as a modulation method of the high speed radio data communication system because of high band efficiency and multi-path fading resistance.

Basically, the OFDM converts serially-inputted data rows into N parallel data rows, and transmits the resultant data rows with divided subcarriers, thereby improving data efficiency.

Here, the subcarriers must be appropriately selected to maintain an orthogonal property. The subcarriers are generated in a transmission/reception terminal by using IFFT and FFT processors. Accordingly, in order to implement high speed radio data communication like the OFDM, it is required to form a high speed FFT module. In addition, a size of the FFT processor must be reduced for portability in the radio data communication. The size of the FFT processor is increased according to the number of hardware devices such as multipliers, adders and registers.

The Fourier transform performed when signals are represented by consecutive signal rows in a constant time period is a discrete Fourier transform (DFT).

An N point DFT is represented by the following formula 1:

$$X ( k ) = {\sum }_{n = 0}^{N - 1} x ( n ) {W}_{N}^{nk} , n , k = 0 , 1 , … , N - 1$$

Here, a twiddle factor

$$is {W}_{N}^{i} = {ⅇ}^{- j \frac{2 π}{N} nk} .$$

A process for multiplying the twiddle factor by an input data x(n) is divided into trivial multiplication and nontrivial multiplication according to an index (i).

In the case of W₂, W₄, W₈ out of the twiddle factors, the multiplication can be converted into a trivial operation, and thus defined as the trivial multiplication. Conversely, when N is greater than 8, the multiplication is defined as the nontrivial multiplication.

With respect to hardware, the trivial multiplication is implemented by using an adder and a shifter, and thus efficient in area. On the other hand, radix-2³ algorithm which connects three radix-2 butterflies in a pipe line structure is one of the generally-known FFT algorithms.

The radix-2³ algorithm has advantages in area and throughput, by decreasing a number of the nontrivial multipliers according to a general index decomposition method.

FIG. 1 illustrates a signal flow of a 64 point radix-2³ algorithm, wherein a diamond mark (⋄) denotes the trivial multiplication, and a triangle mark ( [symbol] ) denotes the nontrivial multiplication.

FIG. 2 is a structure diagram illustrating a 64 point radix-2³ multi-path delay commutator (MDC) pipeline FFT processor. Referring to FIG. 2, BF2 denotes a radix-2 butterfly, and SW denotes a switch for reordering data. Reference numerals 16, 8, 4, 2, 1 denote delay units between the radix-2 butterflies BF2 and the switches SW.

In addition, W₄ⁱ, W₈ⁱ denote trivial complex multipliers, and W₆₄ⁱ denotes a nontrivial complex multiplier. In general, the multiplier is implemented in the butterfly. However, in order to achieve better understanding of the present invention, the multiplier is displayed outside the butterfly as shown in FIG. 2.

As illustrated in FIG. 2, in the radix-2³ MDC pipeline FFT processor, the nontrivial multiplication is performed after the three radix-2 butterflies BF2.

The number of the complex multipliers is reduced by using the radix-2³ algorithm, and thus the area of the processor is considerably decreased. For example, the 64 point radix-2 butterfly requires 68 nontrivial complex multiplications, while the radix-2³ butterfly requires 43 nontrivial complex multiplications.

As compared with the general radix-2 butterfly, the radix-2³ algorithm can reduce the number of the nontrivial complex multipliers. However, the radix-2³ butterfly is embodied on the basis of the radix-2 butterfly operator, and thus has lower throughput than the algorithm based on higher radix butterfly operator such as the radix-4 or radix-8 butterfly operator.

As a result, there is an increasing demand for the high speed area-efficient FFT processor for the high speed radio communication OFDM system.

### SUMMARY OF THE INVENTION

Accordingly, it is an object of the present invention to provide a fast Fourier transform processor using high speed area-efficient radix-4/2 algorithm which can reduce an area of the processor by minimizing a number of nontrivial complex multipliers, and use the radix-4 butterflies and the radix-2 butterflies in order.

In order to achieve the above-described object of the present invention, there is provided a fast Fourier transform processor using a high speed area-efficient algorithm including: a radix-4 butterfly module for receiving four input signals, and performing a butterfly operation thereon; and a radix-2 butterfly module connected to the radix-4 butterfly module, for performing the butterfly operation on the output signals from the radix-4 butterfly module.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a signal flow of a 64 point radix-2³ algorithm;

FIG. 2 is a structure diagram illustrating a 64 point radix-2³ multi-path delay commutator (MDC) pipeline FFT processor;

FIG. 3 illustrates a signal flow of a 64 point radix-4/2 algorithm; and

FIG. 4 is a structure diagram illustrating a 64 point radix-4/2 MDC pipeline FFT processor.

### DETAILED DESCRIPTION OF THE PREFERRED EMBODIMENT

A fast Fourier transform (FFT) processor using a high speed area-efficient algorithm in accordance with a preferred embodiment of the present invention will now be described in detail with reference to the accompanying drawings.

A high speed area-efficient algorithm in of the present invention is hereinafter referred to as radix-4/2 algorithm for convenience of explanation.

The process for forming the radix-4/2 algorithm will now be explained. Firstly, a radix-4 butterfly and a radix-2 butterfly are selected in order, and decomposed by a three dimensional index map through an index decomposition method, a general method for introducing FFT algorithm, thereby obtaining following formula 2:

$$\begin{matrix}k = \frac{N}{4} {k}_{1} + \frac{N}{8} {k}_{2} + {k}_{3} , 0 \leq {k}_{1} < 3 , 0 \leq {k}_{2} < 1 , 0 \leq {k}_{3} < \frac{N}{8} - 1 \\ n = {n}_{1} + 4 {n}_{2} + {n}_{3} , 0 \leq {n}_{1} < 3 , 0 \leq {n}_{2} < 1 , 0 \leq {n}_{3} < \frac{N}{8} - 1\end{matrix}$$

When the decomposed index is introduced to formula 1, formula 1 is equal to following formula 3:

$$\begin{matrix}X ( k ) = X ( {k}_{1} + 4 {k}_{2} + 8 {k}_{3} ) \\ = {\sum }_{{n}_{3} = 0}^{\frac{N}{8} - 1} {\sum }_{{n}_{2} = 0}^{1} {\sum }_{{n}_{1} = 0}^{3} x ( \frac{N}{4} {n}_{1} + \frac{N}{8} {n}_{2} + {n}_{3} ) {W}_{N}^{( \frac{N}{4} {n}_{1} + \frac{N}{8} {n}_{2} + {n}_{3} ) ( {k}_{1} + 4 {k}_{2} + 8 {k}_{3} )} \\ = {\sum }_{{n}_{3} = 0}^{\frac{N}{8} - 1} {\sum }_{{n}_{2} = 0}^{1} \{ [ BF4 ( \frac{N}{8} {n}_{2} + {n}_{3} , {k}_{1} ) ] {W}_{N}^{( \frac{N}{8} {n}_{2} + {n}_{3} ) k1} \} {W}_{N}^{( \frac{N}{8} {n}_{2} + {n}_{3} ) ( 4 {k}_{2} + 8 {k}_{3} )} \\ = {\sum }_{{n}_{3} = 0}^{\frac{N}{8} - 1} {\sum }_{{n}_{2} = 0}^{1} [ BF4 ( \frac{N}{8} {n}_{2} + {n}_{3} , {k}_{1} ) ] {W}_{N}^{( \frac{N}{8} {n}_{2} + {n}_{3} ) ( {k}_{1} + 4 {k}_{2} + 8 {k}_{3} )}\end{matrix}$$

Here, a twiddle factor is represented by following formula 4:

$$\begin{matrix}{W}_{N}^{( \frac{N}{8} {n}_{2} + {n}_{3} ) ( {k}_{1} + 4 {k}_{2} + 8 {k}_{3} )} = {W}_{N}^{{Nn}_{2} {k}_{3}} {W}_{N}^{\frac{N}{8} {n}_{2} ( {k}_{1} + 4 {k}_{2} )} {W}_{N}^{{n}_{3} ( {k}_{1} + 4 {k}_{2} )} {W}_{N}^{8 {n}_{3} {k}_{3}} \\ = {W}_{8}^{{n}_{2} ( {k}_{1} + 4 {k}_{2} )} {W}_{N}^{{n}_{3} ( {k}_{1} + 4 {k}_{2} )} {W}_{\frac{N}{8}}^{{n}_{3} {k}_{3}}\end{matrix}$$

Here,

$${W}_{8}^{{n}_{2} ( {k}_{1} + 4 {k}_{2} )}$$

is a trivial multiplication coefficient.

Formula 4 is introduced to formula 3, to obtain following formula 5:

$$\begin{matrix}X ( k ) = X ( {k}_{1} + 4 {k}_{2} + 8 {k}_{3} ) \\ = {\sum }_{{n}_{3} = 0}^{\frac{N}{8} - 1} [ {\sum }_{{n}_{2} = 0}^{1} [ BF4 \frac{N}{8} {n}_{2} + {n}_{3} , {k}_{1} ) ] {W}_{8}^{( {n}_{2} ( {k}_{1} + 4 {k}_{2} )} ] {W}_{N}^{( {n}_{3} ( {k}_{1} + 4 {k}_{2} )} {W}_{\frac{N}{8}}^{{n}_{3} , {k}_{3}} \\ = {\sum }_{{n}_{3} = 0}^{\frac{N}{8} - 1} [ H ( {n}_{3} , {k}_{1} , {k}_{2} ) {W}_{N}^{{n}_{3} ( {k}_{1} + 4 {k}_{2} )} ] {W}_{\frac{N}{8}}^{{n}_{3} {k}_{3}}\end{matrix}$$

Here, H(n₃,k₁,k₂) is represented by following formula 6:

$$\begin{matrix}H ( {n}_{3} , {k}_{1} , {k}_{2} ) = {\sum }_{{n}_{2} = 0}^{1} [ BF4 ( \frac{N}{8} {n}_{2} + {n}_{3} , {k}_{1} ) ] {W}_{8}^{( {n}_{2} ( {k}_{1} + 4 {k}_{2} )} \\ = BF4 ( {n}_{3} , {k}_{1} ) + BF4 ( {n}_{3} + \frac{N}{8} , {k}_{1} ) {W}_{8}^{( {k}_{1} + 4 {k}_{2} )}\end{matrix}$$

As shown in formula 6, the radix-4/2 algorithm is embodied by one radix-4 DIF butterfly operator and one radix-2 DIF butterfly operator, and includes the trivial multiplication of W₈.

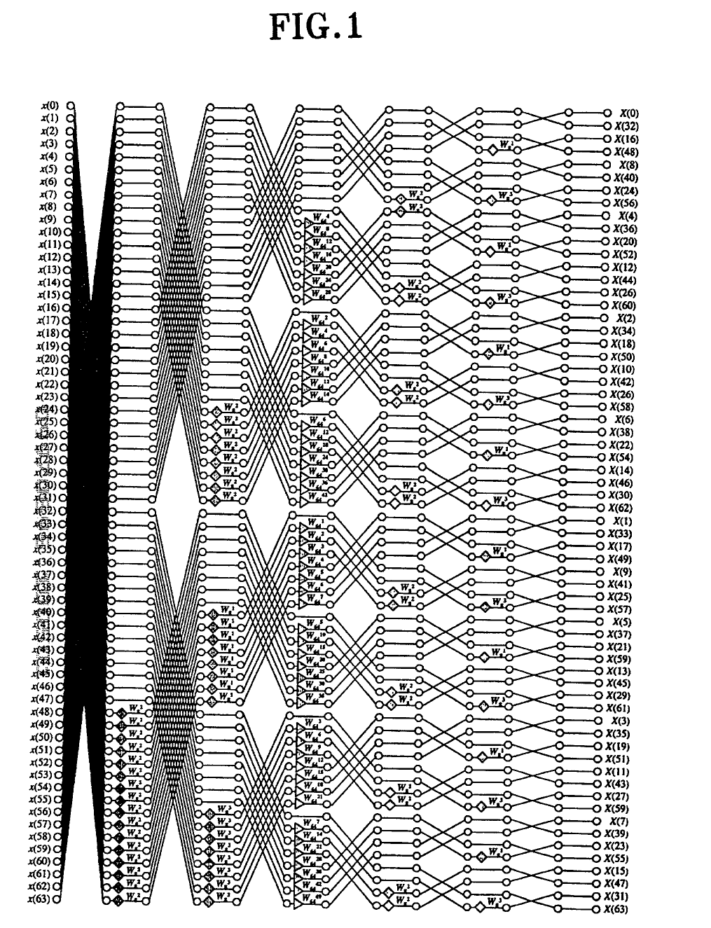

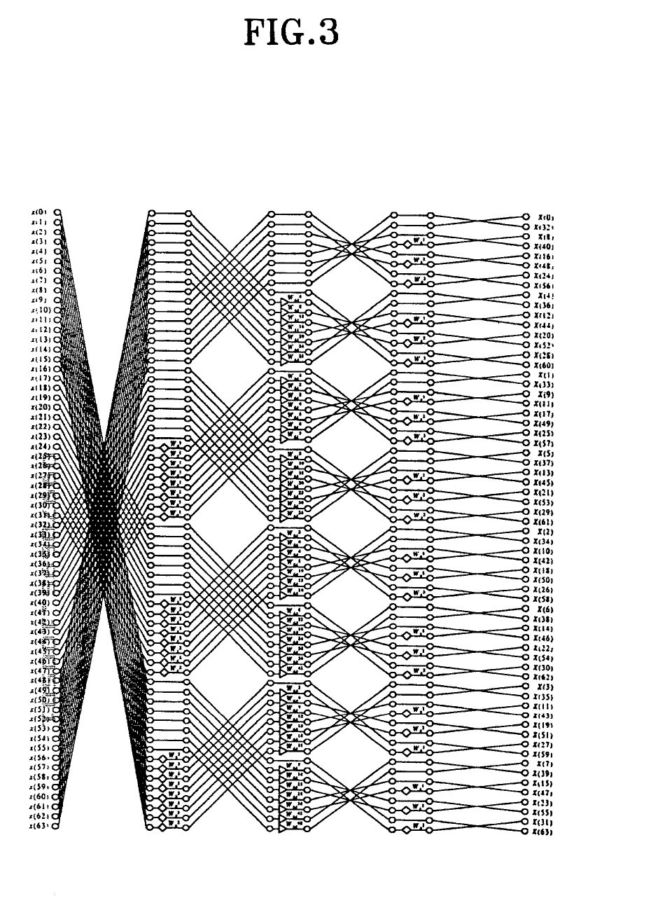

Referring to FIG. 3 which illustrates a signal flow graph of the 64 point radix-4/2 algorithm, a diamond mark (⋄) denotes the trivial multiplication, and a triangle mark ( [symbol] ) denotes the nontrivial multiplication. A nontrivial complex multiplication is performed after sequentially performing one radix-4 butterfly operation and one radix-2 butterfly operation. In addition, as compared with the 64 point radix-2³ algorithm of FIG. 1, the number of the nontrivial multiplications ( [symbol] ) is considerably reduced.

The FFT processor using the radix-4/2 algorithm in accordance with the present invention will now be described. In general, the FFT processor is embodied as a hardware by using a single butterfly operator structure, a pipeline structure or a parallel structure. The parallel structure is advantageous in throughput, but very complicated in hardware. On the other hand, the single butterfly operator structure is less complicated, but has low throughput. The FFT processor for the wireless LAN system must have high throughput for a high speed operation and little complicity for portability. According to the preferred embodiments of the present invention, the FFT processor is embodied in the pipeline structure having satisfactory throughput and complicity.

As the pipeline fast Fourier transform processor, there are a Multi-path Delay Commutator (MDC) fast Fourier transform processor, a Single-path Delay Feedback (SDF) fast Fourier transform processor and a Single-path Delay Commutator (SDC) fast Fourier transform processor. Among these, the MDC fast Fourier transform processor will be explained in the present embodiment.

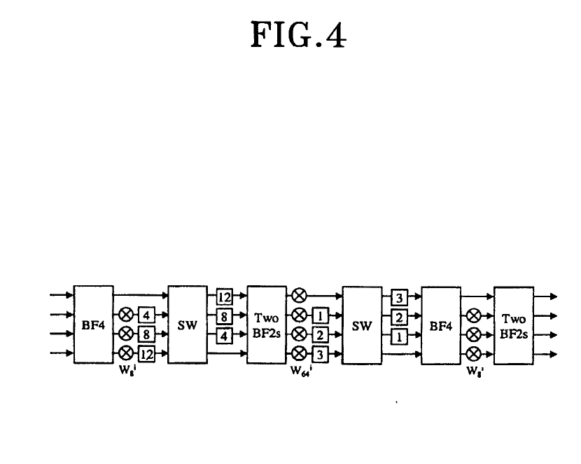

Referring to FIG. 4 which illustrates a 64 point radix-4/2 MDC pipeline FFT processor, BF2 denotes a radix-2 butterfly, BF4 denotes a radix-4 butterfly, and SW denotes a switch for reordering data. Delay units 1, 2, 3, 4, 8 and 12 are positioned respectively among the radix-4 butterflies BF4, the radix-2 butterflies BF2 and the switches SW. In addition, W₈ⁱ denotes a trivial complex multiplier, and W₆₄ⁱ denotes a nontrivial complex multiplier.

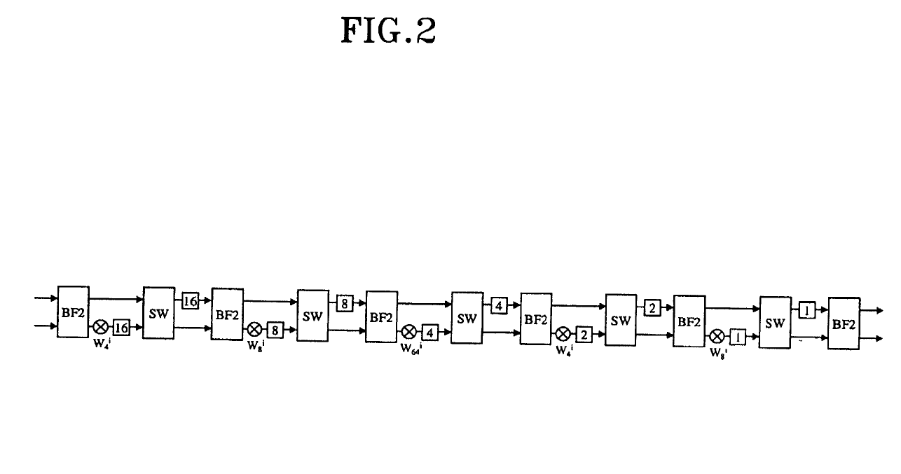

In general, the multiplier is implemented in the butterfly. However, in order to achieve better understanding of the present invention, the multiplier is displayed outside the butterfly as shown in FIG. 4. In the radix-4/2 MDC pipeline FFT processor, the nontrivial multiplication is performed after the radix-4 butterfly BF4 and the radix-2 butterfly BF2. On the other hand, when the 64 point radix-4/2 MDC pipeline FFT processor in FIG. 4 is compared with the 64 point radix-2³ MDC pipeline FFT processor in FIG. 2, the radix-4/2 FFT processor receives 4 point input data through an input terminal, and thus has higher speed than the radix-2³ FFT processor receiving 2 point input data by two times.

In this embodiment, the 64 point radix-4/2 algorithm is embodied in the MDC pipeline FFT processor. However, it is merely one example that the algorithm is applied to the FFT processor.

Although the preferred embodiment of the present invention has been described, it is understood that the present invention should not be limited to this preferred embodiment but various changes and modifications can be made by one skilled in the art within the spirit and scope of the present invention as hereinafter claimed.

As discussed earlier, the FFT processor using the high speed area-efficient algorithm has the following advantages. The 64 point radix-4/2 algorithm reduces the number of the nontrivial complex multipliers more than the general radix-4 or radix-2 algorithm by about 33%, and thus is efficient in area. In addition, the radix-4/2 algorithm is embodied on the basis of the radix-4, thereby operating four input data at a time. Accordingly, the radix-4/2 algorithm increases the throughput more than the general radix-2³ algorithm operating two data at a time by two times. As a result, the radix-4/2 algorithm can perform a high speed operation. Moreover, the MDC pipeline FFT processor using the radix-4/2 algorithm is efficient in speed and area, and thus suitable for the high speed radio communication modulation such as the OFDM.

What is claimed is:

1. A fast Fourier transform processor implementing a high speed area-efficient algorithm comprising:
a radix-4 butterfly module for receiving four input signals, and performing a butterfly operation on the input signals; and
a radix-2 butterfly module connected to the radix-4 butterfly module, for performing the butterfly operation on output signals from the radix-4 butterfly module.

2. The processor according to claim 1, further comprising a nontrivial complex multiplier unit connected to the radix-2 butterfly module for performing a nontrivial complex multiplication after one radix-4 butterfly operation and one radix-2 butterfly operation are sequentially performed by the radix-4 butterfly module and the radix-2 butterfly module, respectively.

3. The processor according to claim 1, wherein the algorithm is implemented according to an index decomposition method.

4. The processor according to claim 1, wherein the processor is a multi-path delay commutator pipeline fast Fourier transform processor using the algorithm.

5. The processor according to claim 1, wherein the processor is an SDF pipeline fast Fourier transform processor using the algorithm.

6. The processor according to claim 1, wherein the processor is an SDC pipeline fast Fourier transform processor using the algorithm.

7. The processor according to claim 1, further comprising a switch disposed between the radix-4 butterfly module and the radix-2 butterfly module for reordering data.

8. A fast Fourier transform processor using a high speed area-efficient algorithm comprising:
a first radix-4 butterfly module for receiving four input signals, and performing a butterfly operation on the input signals;
first and second radix-2 butterfly modules, connected to the first radix-4 butterfly module, for performing the butterfly operation on output signals from the radix-4 butterfly module;
a second radix-4 butterfly module, connected to the first and second radix-2 butterfly modules, for performing the butterfly operation on output signals from the first and second radix-2 butterfly modules; and
third and fourth radix-2 butterfly modules connected to the second radix-4 butterfly module, for performing the butterfly operation on output signals from the second radix-4 butterfly module.

9. The processor according to claim 8, further comprising a nontrivial complex multiplier unit disposed between the first and second radix-2 butterfly modules and the second radix-4 butterfly module for performing a nontrivial complex multiplication after a radix-4 butterfly operation and a radix-2 butterfly operation are sequentially performed by the first radix-4 butterfly module and the first and second radix-2 butterfly modules, respectively.
